(19) United States
(12) Patent Application Publication
(10) Pub. No.: US 2004/0256607 A1
(43) Pub. Date: Dec. 23, 2004

(54) Portable hoist system

(76) Inventor: Michael Spitsbergen, Abilene, TX (US)

Correspondence Address: Alan R. Thiele, JENKENS & GILCHRIST, 3200 Fountain Place, 1445 Ross Avenue, Dallas, TX, 75202-2799, US

(21) Appl. No.: 10/464,308

(22) Filed: Jun. 18, 2003

(51) Int. Cl. B66D 1/00

(52) U.S. Cl. 254/334; 254/323

(57) ABSTRACT

A portable hoist system includes a base assembly which includes a pintle. Slidably mounted over the pintle is a hoist support assembly. The hoist support assembly includes a substantially vertical tube which is connected at its top portion to a support arm. The support arm is supported with respect to the substantially vertical tube by an angled brace member. On the top of the support arm is located a lifting strap control assembly. The lifting strap control assembly includes a windlass and a guide bar. Further disclosed is a base assembly support system which is connectable to the hitch receiver portion of a tow bar assembly on a vehicle such as a pickup truck.

### FIELD

The present invention relates to a portable hoist system; more particularly the portable hoist system of the present invention relates to a lightweight portable lifting hoist which may be used with a vehicle having a tow bar system mounted thereon.

### BACKGROUND

In many situations, it is often necessary for owners of vehicles such as pickup trucks to place a heavy or large load in the open bed of the pickup truck—which load is not easily lifted manually by one or even two people. One solution to this problem has been the creation of hydraulic systems which raise and lower a platform from ground level to the level of the truck bed. While first used on large commercial vehicles, these hydraulic lifts have become smaller over the years and are now sized to be used on pickup trucks and large vans. One manufacturer of these hydraulic liftgates sells them under the brand TommyLift™. While small hydraulic liftgate systems enable the lifting of heavy or bulky loads, such systems are expensive and complex, as they include not only a mechanical system of arms and levers, but they also include the hydraulics needed to provide the lifting power and an electrical system to control the operation of the hydraulic lifting system. Accordingly, a hydraulic liftgate system is typically too expensive and too complex for the owner of a pickup truck who does not lift heavy or bulky loads on a regular basis. One category of such vehicle owner carries small motorcycles, jet skis or four-wheelers in the bed of their pickup trucks. If help is not available, it is all but impossible for a single individual to load or unload a motorcycle, a jet ski, or a four-wheeler from the bed of a pickup truck.

A similar situation occurs with the use of an automobile or van. Oftentimes it may be necessary for the owner of an automobile to load heavy cargo into the trunk. But unlike hydraulic liftgates for trucks, there are no hydraulic systems available for automobiles which facilitate placing a heavy or bulky load into the trunk of an automobile.

In the bed of pickup trucks, in the trunks of automobiles, and in the back of vans, it is not practical or economical to mount a permanent hoist for the lifting of loads. Accordingly, there remains a need in the art for a lightweight portable hoist system which may be easily used with a truck, an automobile, a van, or in other similar applications.

### SUMMARY

The portable hoist system of the present invention is a light-weight, easily assembled, inexpensive system which may be readily moved from place to place by one person, thus providing an individual with the ability to move loads to or from the cargo space of a vehicle.

The portable hoist system of the present invention includes a substantially vertical tube. The substantially vertical tube is connected at its top portion to a support arm. The support arm is supported with respect to the substantially vertical tube by an angled brace member. On the top of the support arm is located a cable or strap assembly. The cable or strap assembly includes a windlass and a guide bar or rotating spool. Supporting the substantially vertical tube is a holster. The holster is supported by a base assembly. Support for the base assembly is provided by connection to a tow bar assembly commonly found on many vehicles.

### BRIEF DESCRIPTION OF THE DRAWING FIGURES

A better understanding of the portable hoist system of the present invention may be had by reference to the drawing figures wherein:

FIG. 1 is a perspective view of a first embodiment of the hoist assembly of the present invention;

FIG. 2 is a side elevational view of the portable hoist system installed on a pintle on a base as shown in FIG. 1;

FIG. 3 is a side elevational view of the hoist support assembly in a partially folded condition with the brace removed;

FIG. 4 is a side elevational view, in partial section, of the hoist support assembly with a folding angled brace member;

FIG. 5 is a bottom plan view of the support arm shown in FIG. 4 with the folding angled brace member contained therein;

FIG. 6 is a side elevational view of a small pickup style truck including the portable hoist system in its cargo space;

FIG. 7 is a side elevational view of an automobile including the portable hoist system in its trunk;

FIG. 8 is a perspective view of the portable hoist system installed in the cargo space of a pick-up truck using a first alternate embodiment of the base assembly;

FIG. 9 is a perspective view of the portable hoist system installed in the back of a van;

FIG. 10 is a perspective view of the portable hoist system installed on a trailer;

FIG. 11 is a perspective view of a second alternate embodiment of the base assembly;

FIGS. 12A, 12B, and 12C are a series of perspective views, illustrating the assembly of the portable hoist system;

FIG. 13 is a side elevational view of the portable hoist system assembled as shown in FIGS. 12A, 12B, and 12C and mounted on a base assembly;

FIG. 14A is a right side elevational view of the portable hoist assembly on a bipod mount for use with the hitch receiver on the back of a truck;

FIG. 14B is a top plan view of the system shown in FIG. 14A;

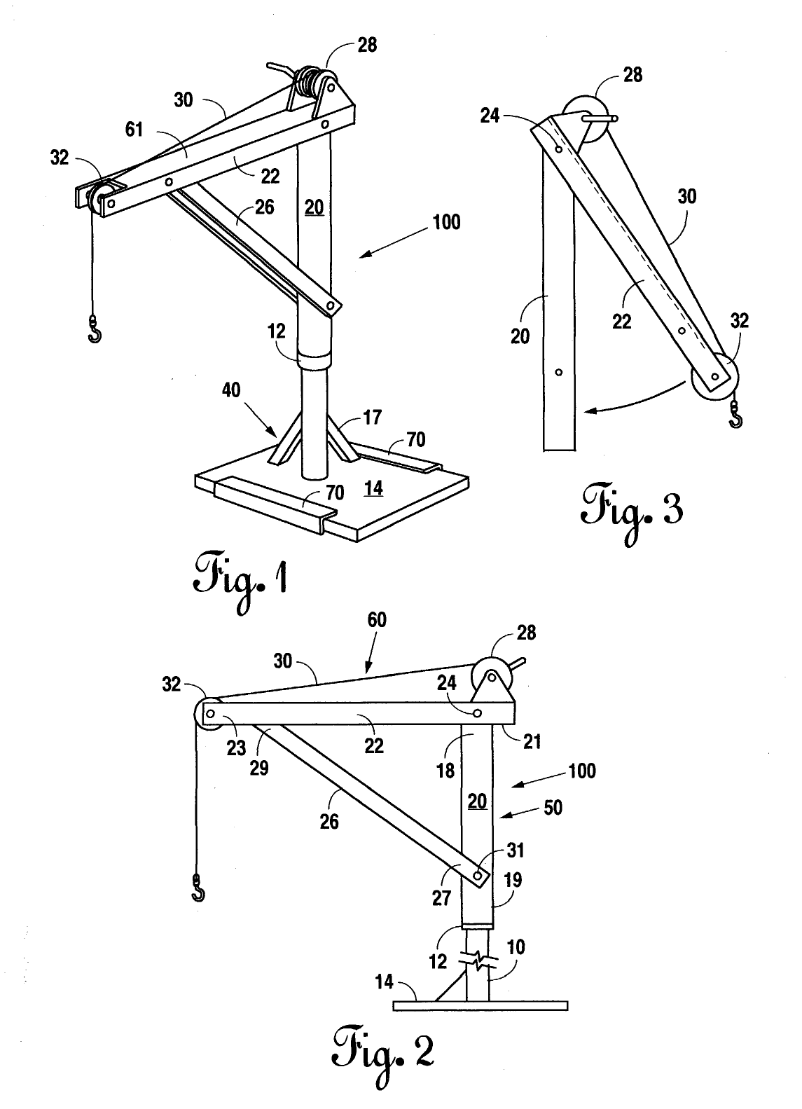

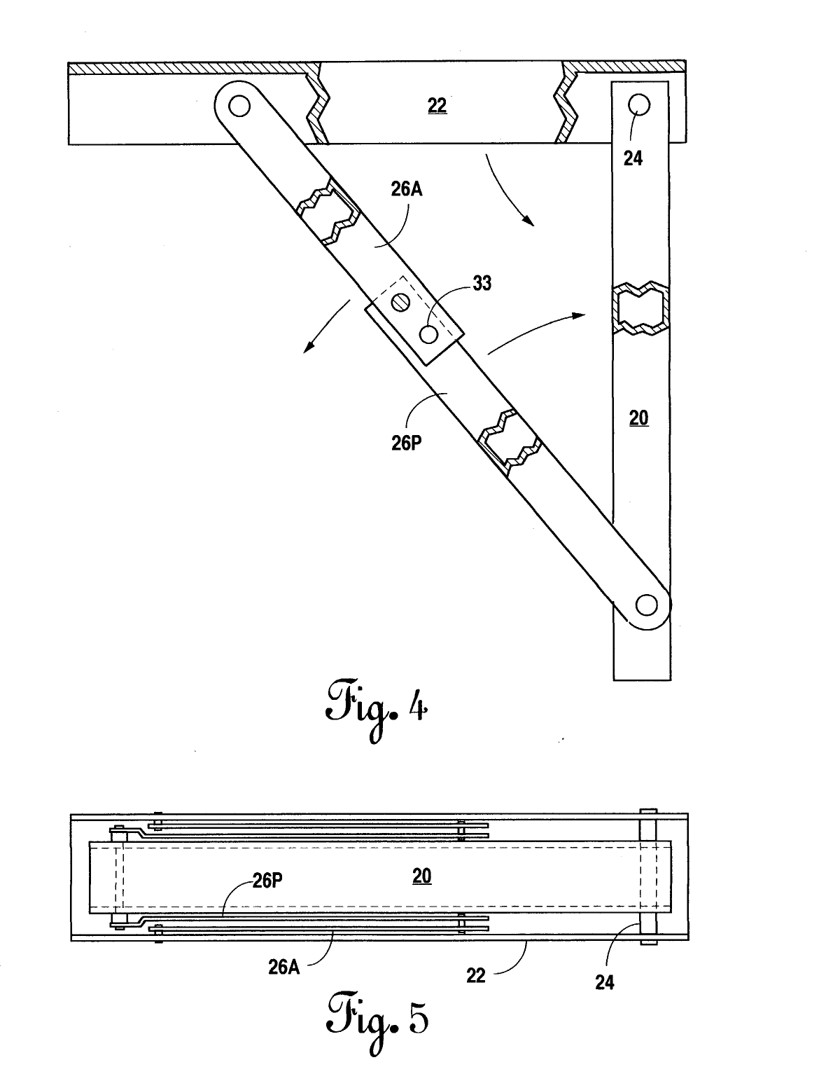

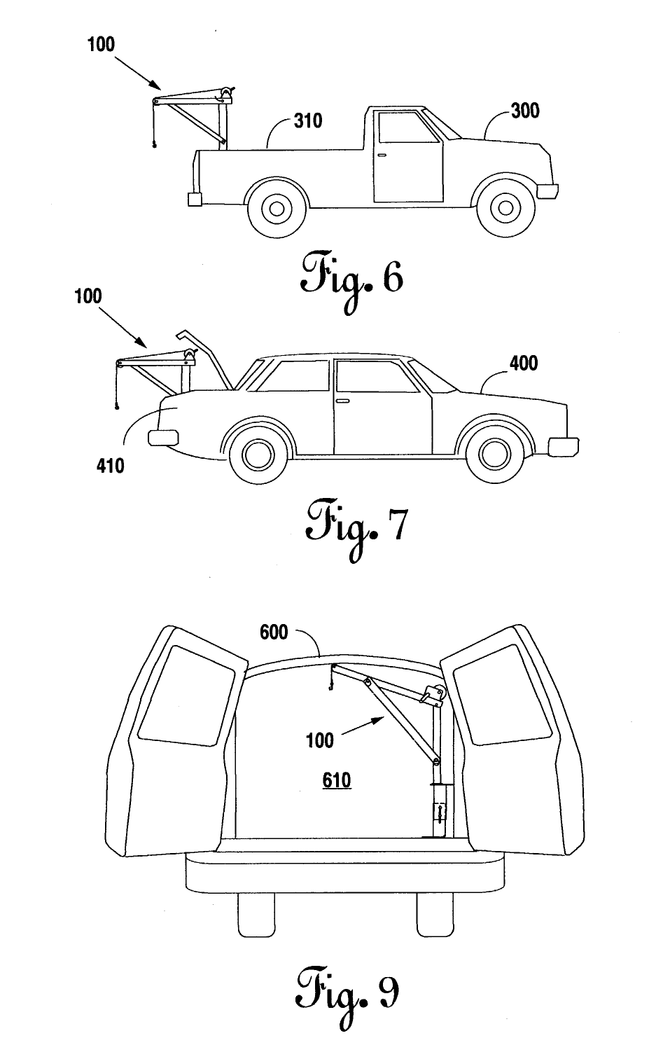

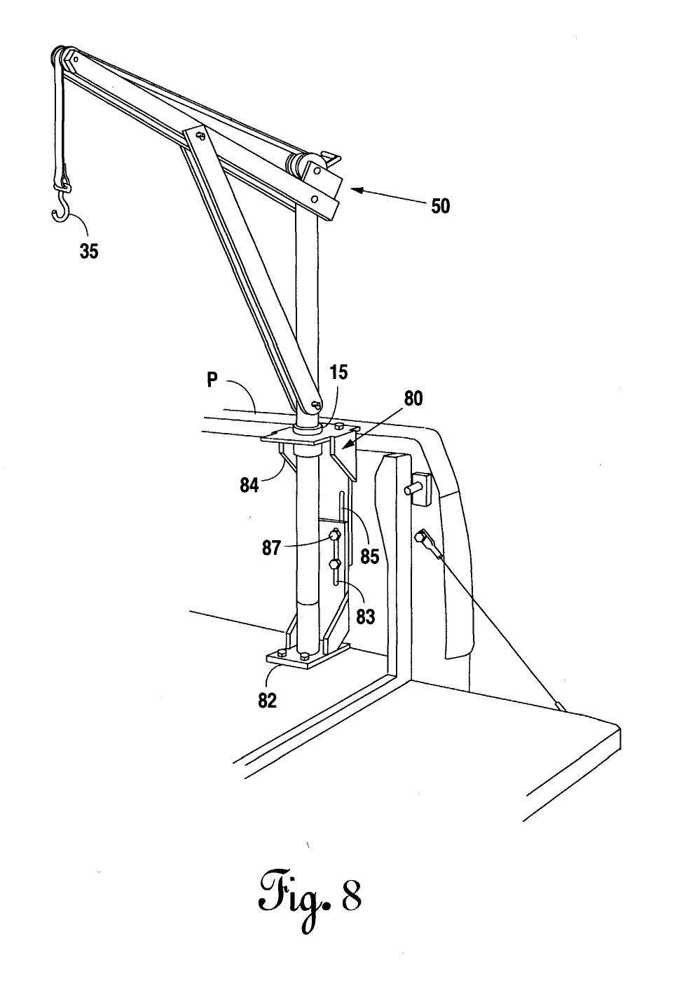

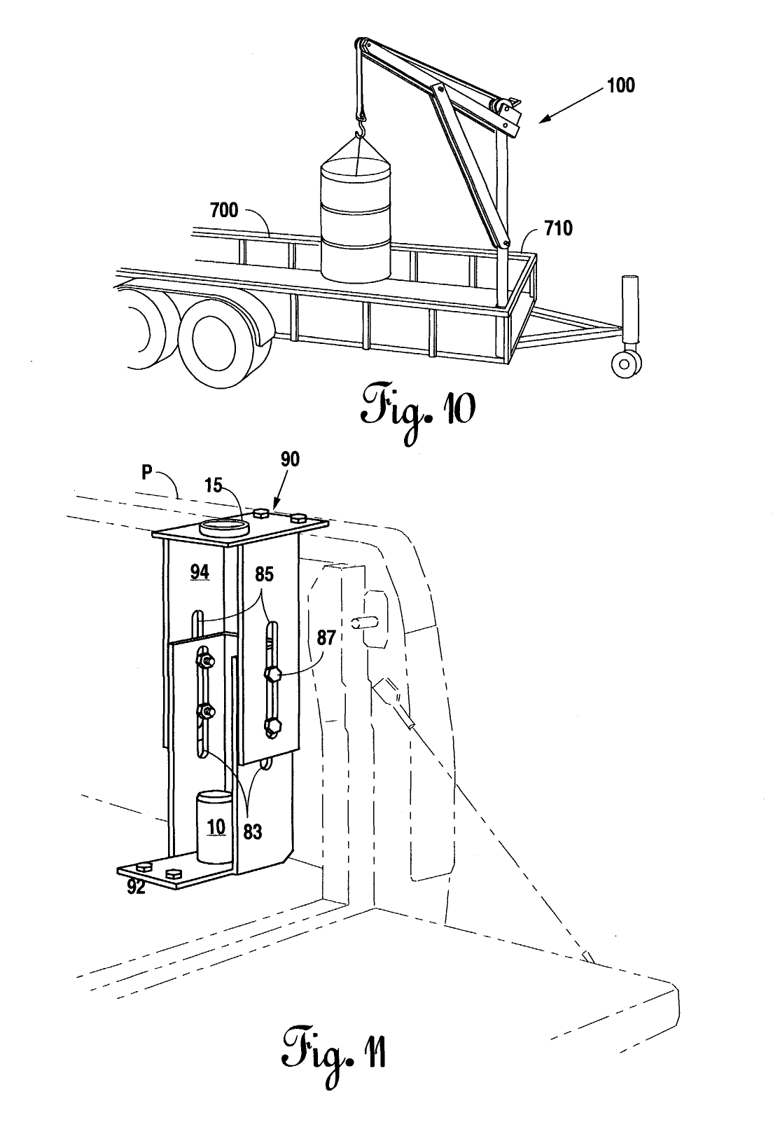

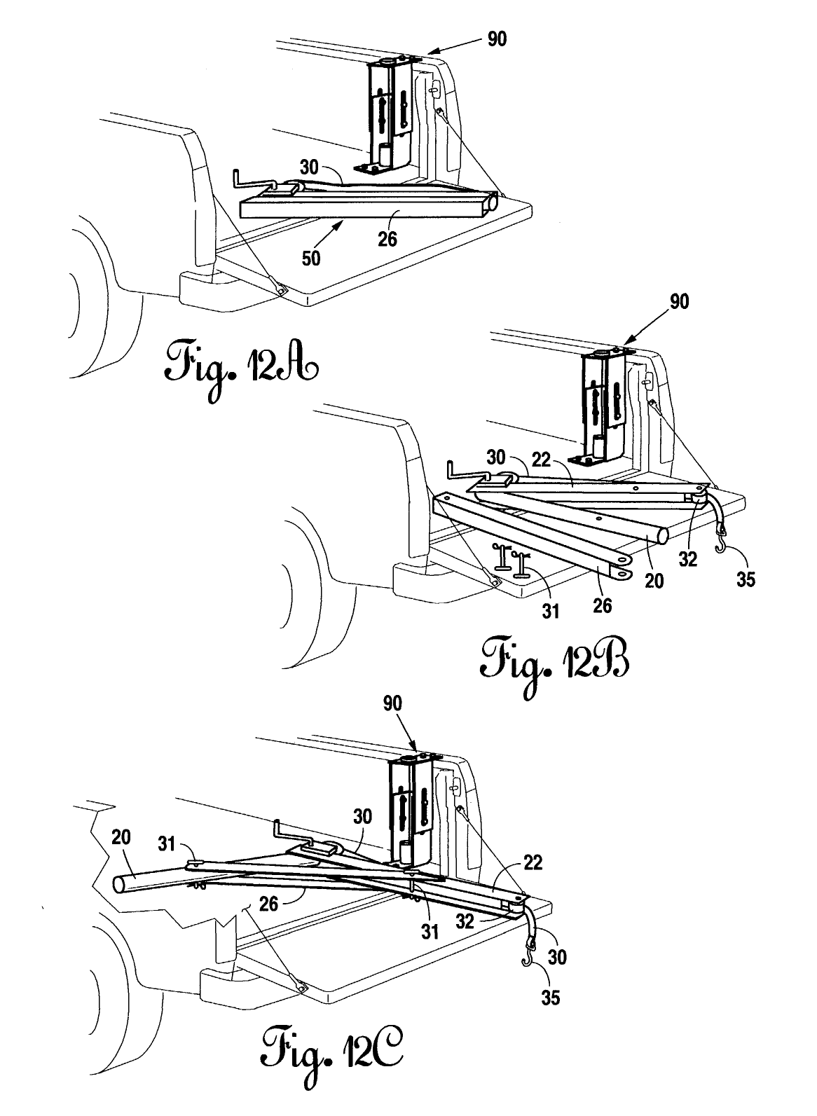

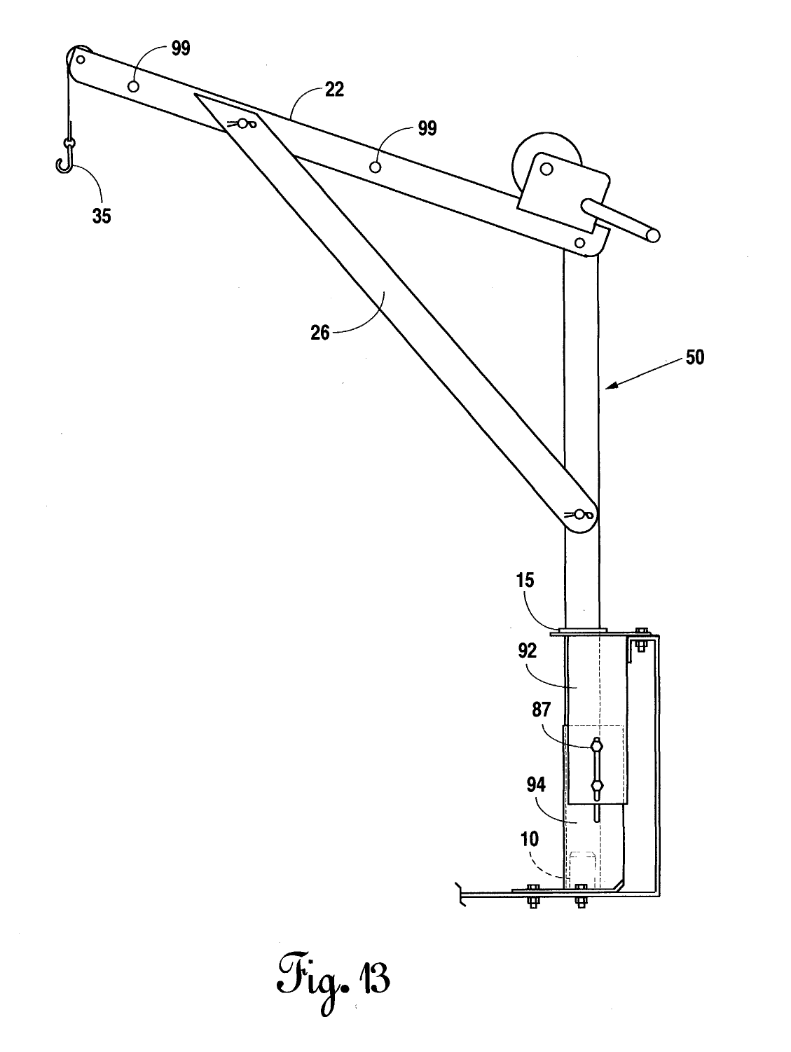

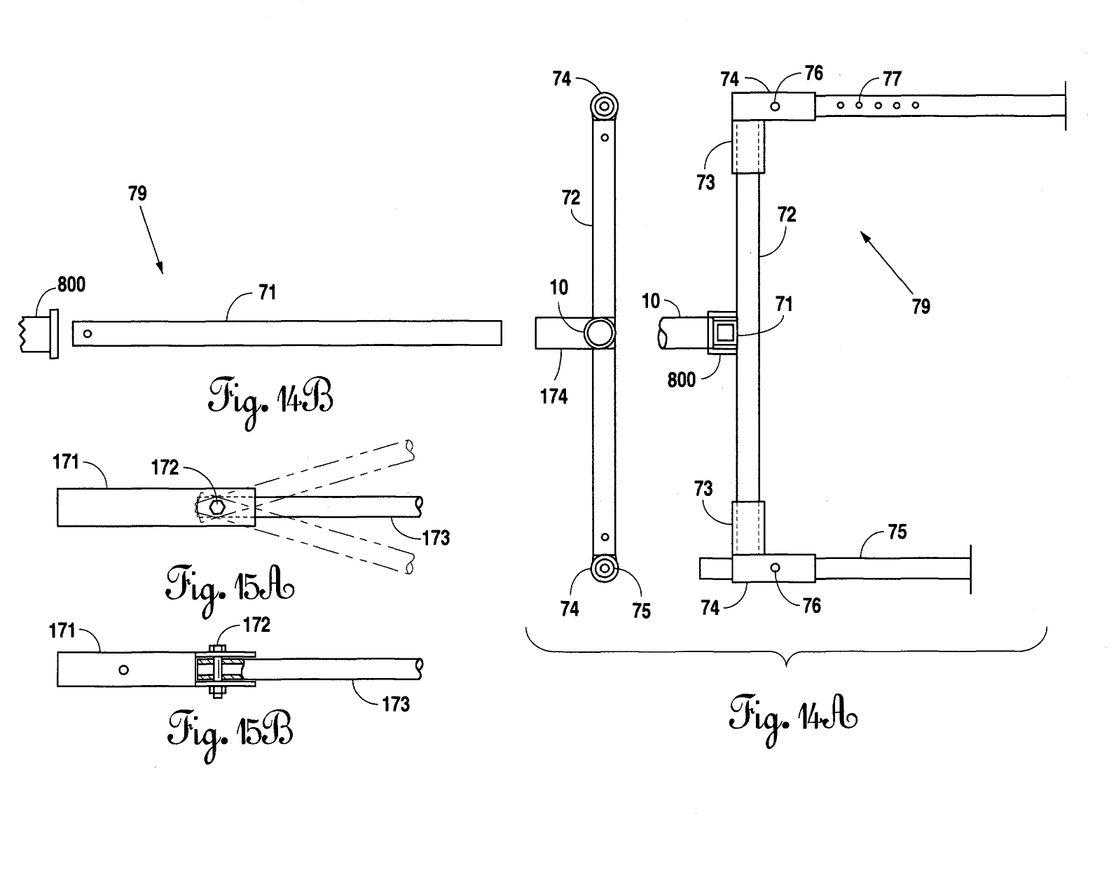

FIG. 1 5A. is a top plan view of an alternate embodiment of a connection to a hitch receiver; and

FIG. 15B is a side elevational view, in partial section, of the connection shown in FIG. 15A.

FIG. 16A is an exploded perspective view of a second alternate embodiment of the hoist assembly for use with the hitch receiver portion of a tow bar assembly;

FIG. 16B is a perspective view of the bottom of the base support assembly connected to the hitch receiver;

FIG. 16C is a perspective view of the base support assembly including the holster base assembly;

FIG. 16D is a perspective view of the base support assembly and portable hoist assembly connected to the hitch receiver; and

FIG. 16E is a perspective view similar to FIG. 16D showing the placement or removal of a load from the back of a pickup truck.

### DESCRIPTION OF THE EMBODIMENTS

As shown in FIG. 1 and FIG. 2, a key feature of the portable hoist system 100 of the present invention is the base assembly 40. As will be understood by those of ordinary skill in the art, the construction of the base assembly is determined in large part by the environment in which the portable hoist system 100 is used. In the first embodiment of the base assembly 40 shown in FIG. 1, a substantially vertical pintle 10 is firmly attached to a platform, be it in the open bed 310 of a pickup truck 300 (FIG. 6), in the trunk 400 of an automobile 400 (FIG. 7), in the cargo space 610 of a van 600 (FIG. 9), on the side rail 710 of a trailer 700 (FIG. 10), or other location which provides adequate support for the portable hoist system 100 and any load to be picked up.

As shown in FIG. 1, the pintle 10 may be mounted upon a plate 14 which has an extending foot therefrom. In most applications the extending foot may extend outwardly in one direction. The plate 14 may be built into the cargo space of a vehicle or it may be fit into a mounting system such as the parallel pair of angle iron pieces 70 shown in FIG. 1.

As shown in FIG. 2, the substantially vertical tube 20 portion of the hoist support assembly 50 is removably telescoped over the pintle 10 for full rotation of the hoist support assembly 50 with respect to the pintle 10. A support arm 22 extends outwardly and substantially horizontally away from a pinned connection 24 on the top portion 18 of the tube 20, but alternatively, and as will be shown below, the support arm 22 may be angled upwardly with respect to the tube 20 as shown in FIGS. 8, 9, 10 and 13. A brace member 26 extends from near the distal end 23 of the arm 22 to the lower portion 19 of tube 20 to hold the support arm 22 in position when weight is placed thereon.

Therefore, when not in use, only the base assembly need remain in the bed of a truck, in the trunk of a car, or wherever the hoist assembly 50 is used. However, when necessary, the vertical tube 20, the brace 26, and support arm 22 can be readily mounted to the base assembly. A cable or strap control assembly 60 is located on the arm 22. The cable or strap control assembly 60 includes a cable or strap 30 which runs from a windlass drum 28 mounted on the top surface 21 of the arm 22 over a guide bar or rotating spool 32 mounted to the distal end 23 of the support arm 22 and extends downwardly to a hook 35, loop, bar, clevis, or other type of hardware selected to best lift the load to be hoisted.

Referring to the drawings attached hereto, it may be seen in FIG. 1 that the pintle 10, with an optional stop ring 12 near the bottom thereof (for height adjustment) is supported upon a base plate 14.

FIG. 2 shows the base plate 14 and the stop ring 12; however, the substantially vertical tube 20 is telescoped over the pintle 10 so that the top portion is no longer seen. As shown in FIG. 1, various braces 17 are shown to hold the pintle 10 in an upright or vertical position. Such bracing systems are well known to those of ordinary skill in the art.

FIG. 2 shows the tube 20 as it is telescoped over the pintle 10. The support arm 22 is pivotably connected to the tube 20 by a bolt or pin 25 which passes through each one of them. Although not explicitly shown it will be understood that the tube 20 can be folded in a parallel fashion to the arm 22. A partially folded hoist support system appears in FIG. 3. The arm 22 is a channel so that the top 18 of the tube 20 fits between the two channel flanges at the proximal end 21 of the arm 22. This enables the hoist support system 50 to be quickly disassembled and carried.

FIG. 2 shows that a brace member 26 extends from the bottom portion 19 of the substantially vertical tube 20 to the distal end 23 of the arm 22. FIG. 2 shows the windlass drum 28 with its hand crank mounted on the top of the arm 22. The cable or strap 30 extends from the windlass drum over a guide bar or rotating spool 32.

According to the embodiment shown in the drawing figures, the first end 27 of the brace member 26 straddles the tube 20. The flanges formed on the first end 27 of the brace member 26 are held thereto by a bolt or pin 31 passing through the flanges on the first end 27 of the brace member 26. The second end 29 of the brace member 26 may be readily positioned by fitting it into a notch (not shown) which has been cut out of the arm 22 to receive the second end 29 of brace member 26. Alternatively, the brace member 26 may be held in position by a bolt or pin extending through both the arm 22 and the brace member 26.

The main purpose and advantage of the present invention is to have a unit which may be conveniently attached to the bed 310 of a truck 300, the trunk 410 of an automobile 400, the inside of a van 600, or the rail around a trailer 700 and which unit is readily transportable and can be moved and set up by an individual lifting a load.

As will be understood by those of ordinary skill in the art, the portable hoist system 100 can easily be mounted upon any platform such as the deck of a dock, the bed of a trailer, a watercraft, or even an aircraft. A single hoist assembly 100 could be used with a plurality of installed base assemblies 40. A single hoist support assembly 50 could be positioned at various locations by attaching it to one of the pre-installed base assemblies 40. The weight and size of the collapsed hoist support assembly 50 enables it to be easily carried.

The preferred embodiment of the portable hoist system 100 of the present invention is meant only for occasional use. Therefore, a hand crank lockable windlass 28 on the cable or strap control assembly 60 is satisfactory. The windlass 28 is mounted on the top 61 of the support arm 22. If desired, however, the windlass 28 could be a motorized unit. Such motorized units could either be pneumatic or electric. When the lifting job is completed, the hoist support assembly 50 together with the cable control assembly 60 can be quickly removed, the brace member 26 dismantled and the other parts folded up into a neat bundle for transport to another location or easy storage. It has been found that a portable hoist system 50 made of structural aluminum weighs about 30 pounds and may have a maximum lifting capacity of nearly 1000 pounds. Aluminum was chosen for the preferred embodiment because it remains cool to the touch even in hot weather, it resists corrosion, and is inexpensive. Alternatively, other high strength, lightweight metals such as titanium may also be used as long as the weight of the hoist support assembly 50 does not exceed the weight easily transportable by an individual.

Many variations of the present invention are available. For example, the brace member 26 could be attached to ears (not shown) extending to near the lower portion 19 of the support tube 20. As shown in FIGS. 4 and 5, the brace member 26 could be a two piece 26A, 26P channel which could be permanently attached to the support arm 22 to be foldable into the confines of the larger channel of the support arm 22 and then the tube 20 could be folded within the brace member 26. Specifically, in its working condition, a pull pin 33 would be placed within the middle of the brace member 26 to hold the two parts of the brace member 26A, 26P stiffly together. When it is desired to fold the brace member 26 the pull pin 33 would be removed while all other bolts, hinges, and pins remain in place. As shown specifically in FIG. 5 the substantially vertical tube 20 could also be folded inside the brace member sections 26A, 26P and the brace member sections 26A, 26P would be inside the arm 22. The support arm 22 and the brace member sections 26A, 26P may both be made from channel members. Accordingly, when the long axes of the tube 20, the support arm 22, and the brace member 26 are laid parallel, everything would fold inside the support arm 22. Reassembly of the hoist support assembly 50 would require the insertion of only one pin 33. Folding the hoist support assembly 50 to the carrying position would require the pulling of only one pin 33.

Operation

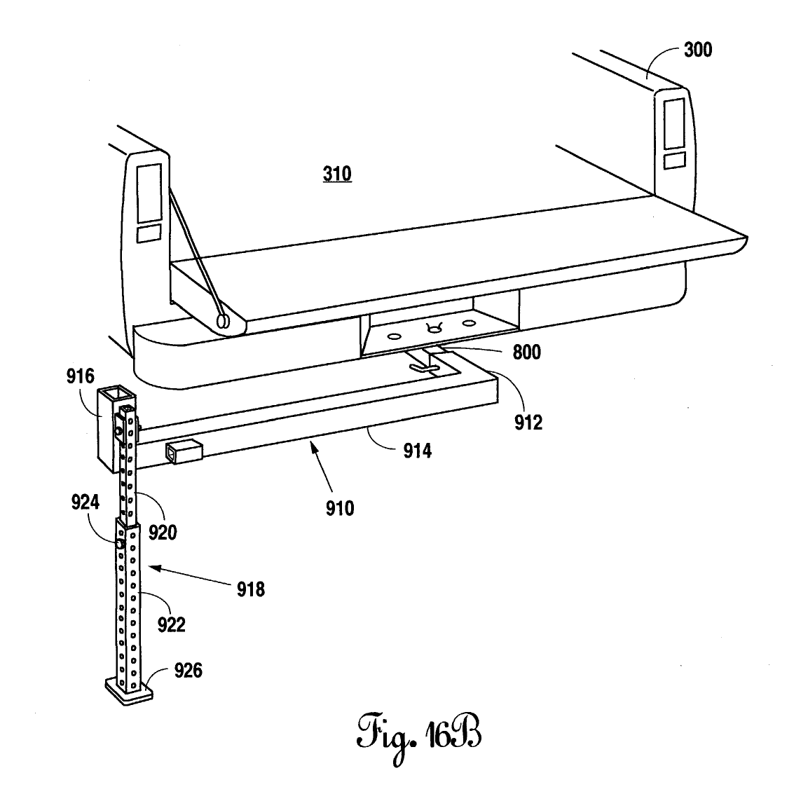

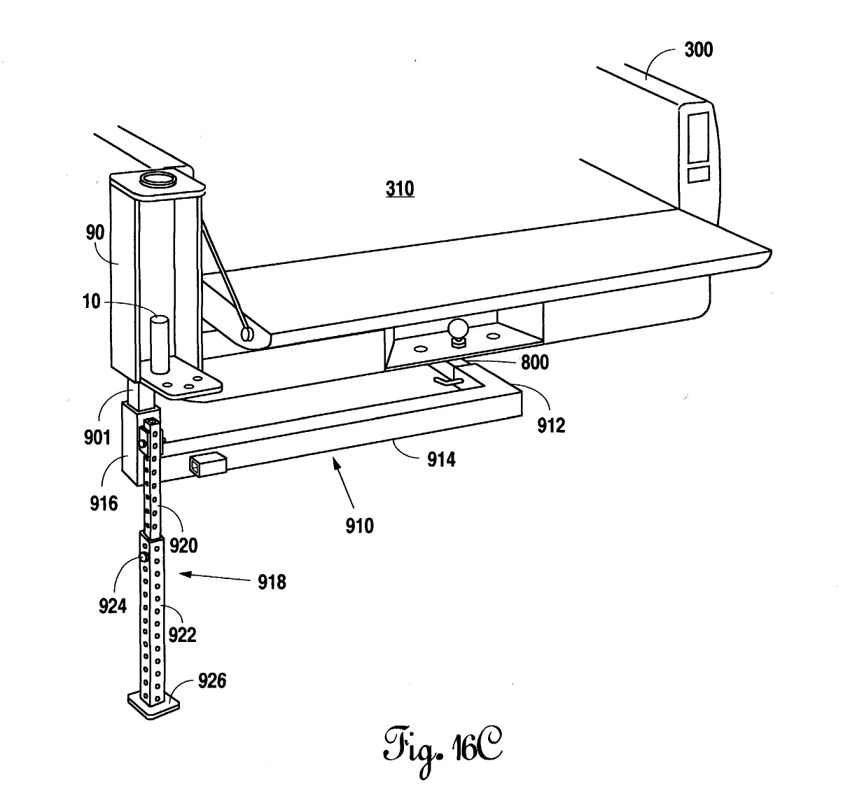

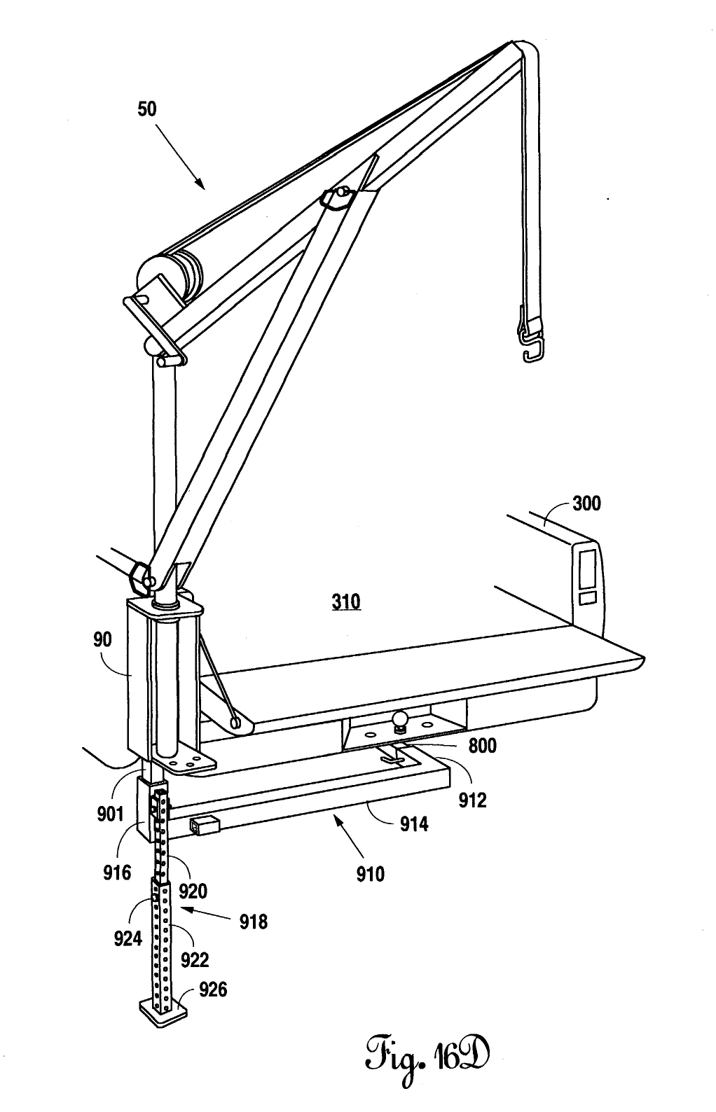

A still better understanding of the portable hoist system of the present invention may be had by a review of its assembly and operation. With specific reference to FIG. 12A, FIG. 12B, FIG. 12C, and FIG. 13, the portable hoist system 50 is folded and held together as a convenient package by use of the lifting strap 30. The folded portable hoist system 50, when disassembled and folded, forms into a package small enough to be placed in the space behind the seat of a pickup truck.

As shown in FIG. 12A assembly of the portable hoist system 50 begins by laying it on its side and loosening the strap 30. This enables the brace member 26 to be removed. The next step is to swing the support arm 22 away from the vertical tube. In the embodiment shown in FIG. 13, the angle between the support arm 22 and the vertical tube 20 is opened up to about 110°. While the embodiment shown in FIG. 1 and the embodiment shown in FIGS. 8, 9, 10, and 13 have different angles between the support arm 22 and the vertical tube 20, those of ordinary skill in the art will understand that a variety of different angles may be used depending on the needed height at the end of the support arm 22. Such selection of angles is facilitated by a set of holes 99 formed in the support arm 22 as shown in FIG. 13.

Once the angle between the vertical tube 20 and the support arm 22 has been opened up, the brace member 26 is attached to both the vertical tube 20 and the support arm 22 using pins or threadable fasteners 31. The strap 30 is then extended over a guide bar or a rotating spool 32 at the end of the support arm 22.

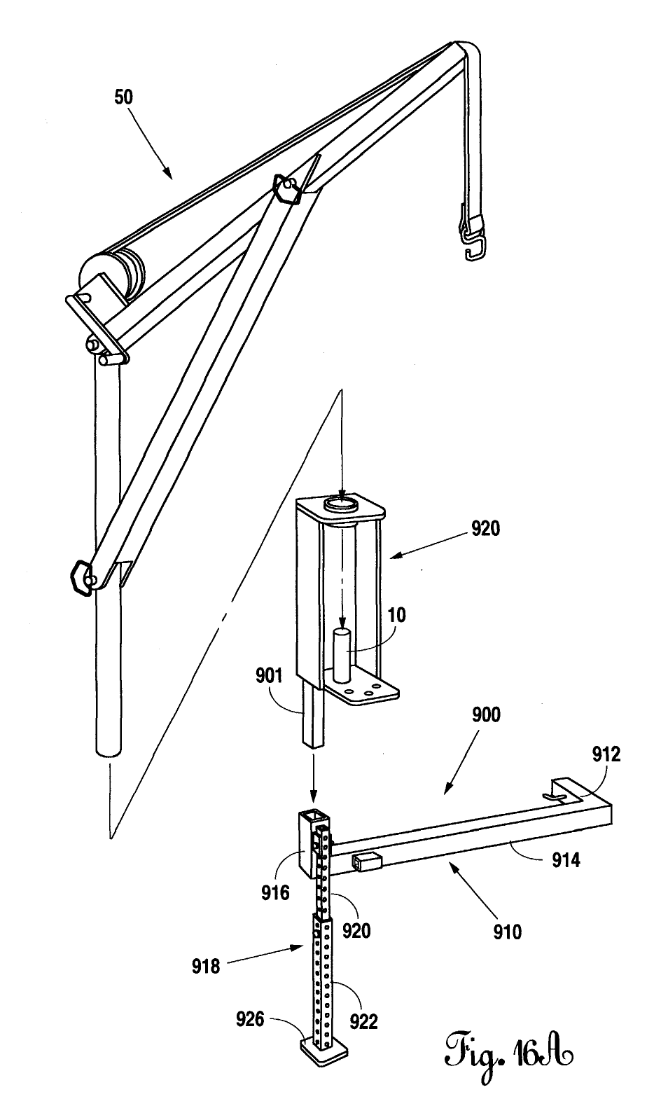

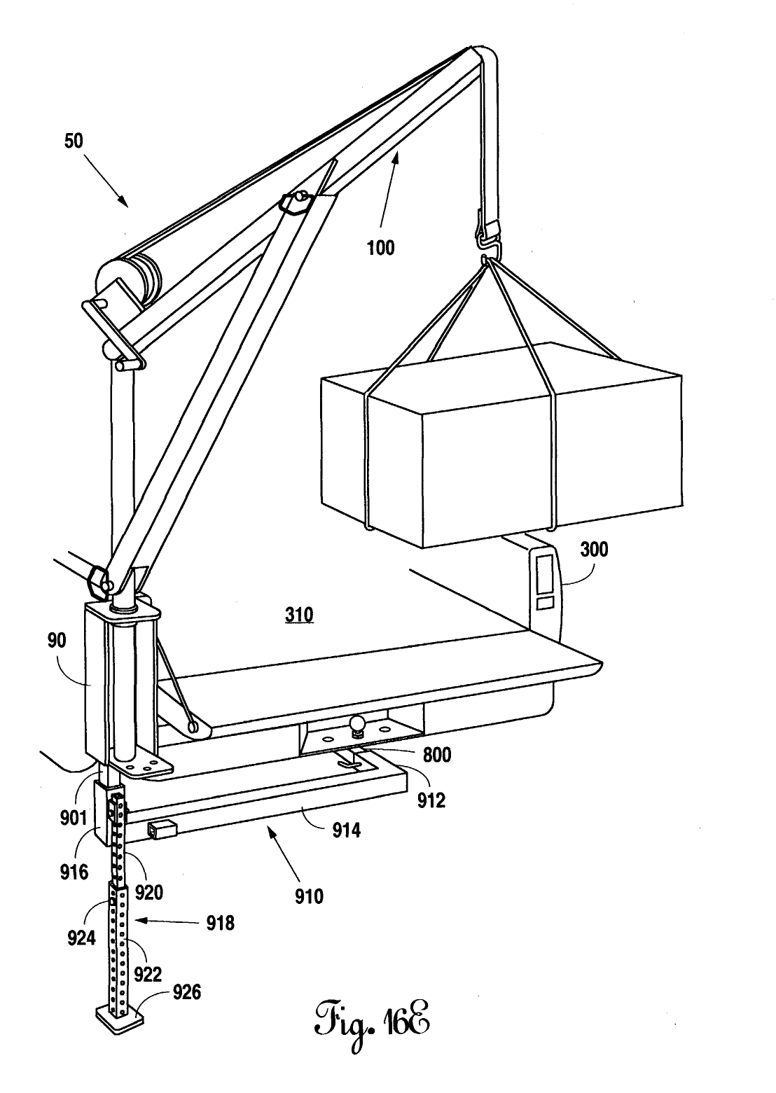

Once set up, the vertical tube 20 is placed either onto a pintle 10 on a base assembly 40 as shown in FIG. 1 or inserted into a first embodiment of a base assembly 80 as shown in FIG. 8 or an alternate embodiment of a base assembly 90 as shown in FIG. 11. This mounting will enable the portable hoist to swing in a full circle. For example, when the hoist assembly 50 is mounted in the cargo space of a truck as shown in either FIG. 8 or FIG. 13, the vertical tube 20 is positioned by sliding first through an upper ring 15 before engaging the pintle 10. Alternatively, the hoist assembly 50 may be mounted to a base assembly extending outwardly from the tow-hitch receiver found on many pick-up trucks or automobiles, as shown in FIGS. 14, 14B, 15A and 15B.

The holster style base assembly 90 as shown in either FIG. 8 or in FIG. 11 is formed from two pieces. The first or lower piece 82, 92 is typically bolted to a horizontal surface such as the floor of the bed of a pickup truck. Note that a pintle 10 is included for insertion into the bottom of the support tube 20.

The second or upper piece 84, 94 of the holster base includes provisions for mounting to a substantially vertical surface and/or to the top of the cargo space side panel P. Included at the top of the upper piece 84, 94 is a ring 15 oriented to be substantially horizontal. The bottom of the vertical tube 20 is guided through the ring 15 for eventual engagement with the pintle 10. If desired, an additional brace member (not shown) may be used with the holster style brace 80, 90. The slot or slots 83 in lower piece 82, 92 are located to be aligned with the slot or slots 85 in the upper piece 84, 94. Once height adjusted, the lower piece 82, 92 and the upper piece 84, 94 are held in position one to another by a nut and bolt assembly 87.

In FIGS. 14A and 14B is shown yet another mounting assembly 79 for the hoist assembly 50. Many trucks have a hitch receiver assembly 800 as part of a tow bar assembly mounted to the frame which includes a substantially square section of tubing extending from the rear of the truck 300. In FIGS. 14A and 14B, an extension arm 71 is inserted into the hitch receiver assembly 800. The extension arm 71 is mounted to a cross bar 72. The cross bar 72 is inserted into receivers 73 on either end. The receivers are mounted to sleeves 74. Extending through the sleeves are two legs 75. By use of pins 76 and a series of holes 77, the legs 75 may be positioned to support the cross bar 72 in a substantially horizontal position. Affixed to the top of the extension arm 71 is either a pintle 10 or a section of pipe for engagement with the support tube 20. If a pintle 10 is used, the support tube 20 is slid over the pintle 10. If a section of pipe is used, the support tube 20 may be inserted into the section of pipe.

In yet another alternate embodiment, as shown in FIGS. 15A and 15B, a shortened extension arm 171 may be used. At the end of the shortened extension arm 171 is a pivotable connection 172 so that the hoist support assembly 79 for use with a hitch receiver may be moved from side to side at the back of the truck. Shown in phantom in FIG. 15A are alternate positions of the support number 173 which is inserted into the sleeve 174 attached to crossbar 72.

While a bipod mount is shown in FIGS. 14A and 14B, a monopod mounting system 900 as shown in FIGS. 16A, 16B, 16C, 16D, and 16E may be used. The disclosed monopod mounting system 900 combines the holster assembly 90, previously described, together with a single leg base support assembly supported in part by the hitch receiver assembly 800 portion of a tow bar assembly. As shown in FIG. 16A, the base support assembly includes an adjustable height bottom portion 910 and a holster assembly 920 which supports the hoist assembly 50. As may be seen in FIG. 16B, a connection piece 912 is inserted into the hitch receiver 800. Attached to the connection piece is an extension arm 914. At the outboard end of the extension arm 914 is a mounting sleeve 916. Extending downwardly from the mounting sleeve 916 is an adjustable support leg assembly 918. The adjustable support leg assembly 918 includes the pieces 920, 922, one telescoped within the other and connected together with a pin 924. Each of these two pieces 922, 924 includes a plurality of holes so that the pin 924 can be used to adjust the length of the leg to assure that the foot 926 on the bottom of the adjustable support leg assembly 918 is in contact with the ground and the extension arm 914 is substantially horizontal. With the connection piece 912 firmly mounted in the hitch receiver 800 and the bottom 926 of the adjustable support leg assembly 918 extended to be in contact with the ground, a holster support piece 901 is inserted into the mounting sleeve 916 as shown in FIG. 16C. The holster assembly 90 is firmly attached to the holster support piece 901. Once the base assembly 910 is in place and the holster assembly 90 is in position, the hoist assembly 50 is placed into the holster assembly 90 as shown in FIG. 16D. As shown in FIG. 16E, the hoist assembly 50 may now be used to lift a load L into the cargo area 310 of a vehicle 300 such as a pickup truck. Once the load L is in place, the hoist assembly 50 may be removed and folded up. The holster assembly 90, together with its support piece 91, is then removed from the mounting sleeve 916. Removing the connection piece 912 from the hitch receiver 800 completes the disassembly process.

Those of ordinary skill in the art will understand the mounting sleeve 916 and adjustable support leg assembly 918 may be made slidable to be positionable within a range of locations along extension arm 914. Such slidable positioning permits mounting of the holster assembly 90 at the best location to facilitate the lifting and movement of a load into a vehicle.

While an open hook 35 is shown on the end of the strap 30, those of ordinary skill will understand that a variety of different lifting devices may be attached at the end of the strap 30 to include closed hooks, plate grippers, lifting bars, or a clevis.

Those of ordinary skill in the art will also realize that two or more hoists may be used with one vehicle to lift particularly heavy loads, off-balance loads, or exceptionally large equipment.

Once installed, the portable hoist system 100 of the present invention may be used to lift a variety of different loads heretofore not movable by a single person. Such loads may include, but is not limited to:

palletized loads

small yard machines

tree stumps

automobile engines

farm equipment

large truck tires

furniture

small off-road vehicles

deer

generators

large poles

small watercraft

rocks

small motorcycles

fuel/oil drums

appliances

Once the lifted item has been placed in the bed of a pickup truck, in a van, in a car, or into the cargo space of any type of vehicle in which it used, the portable hoist assembly 50 of the present invention is simply lifted from its mounting and configured for storage. Specifically, the pins or bolts used to connect the support arm to the brace member are removed. The pins or bolts 31 used to connect the brace member 26 to the substantially vertical tube 20 are also removed. The three parts 20, 22, 26 of the hoist may then be nested together. As the open portion of the channel section brace member 26 is wider than the support arm 22, the support arm 22 may be nested in the channel. Further, since the open section of the channel section support arm 22 is wider than the substantially vertical tube 20, the substantially vertical tube 20 may be nested therein. Once nested together, the strap 30 may be wrapped around the nested parts to both hold them together and provide a convenient carrying handle. For security, the disassembled hoist assembly 50 can be placed within a vehicle at a secure location. When it is necessary to remove the load from the cargo space of the vehicle, the hoist is re-assembled and mounted on the base to lift the transported cargo.

Those of ordinary skill in the art will understand that numerous improvements and modifications may be made to the disclosed portable hoist system without departing from the scope of the invention. Such improvements and modifications may include, but are not limited to:

adding a motor drive or power assist to the winch assembly;

adding a weight indicator;

including a ratchet system in the connection between the substantially vertical tube and the support base;

including a bearing connection such as a ball bearing in the connection between the substantially vertical tube and the support base;

including a light system for night operations;

adding a motor drive or power assist to assist in the rotation of the hoist support assembly about the base;

reinforcing the support arm with a thicker cross section at its distal end.

Still other improvements may be made without departing the basic invention disclosed herein. Such other improvements shall fall within the scope and meaning of the appended claims.

1. A portable hoist system, said portable hoist system comprising:
a hoist support assembly, said hoist support assembly including:
a substantially vertical tube having a bottom portion, a top portion, and a long axis, said bottom portion being constructed and arranged to rotatably engage said pintle;
a channel section support arm having a proximal end, a distal end, a top surface, and a long axis, said proximal end being constructed and arranged to be affixed to said top portion of said substantially vertical tube;
a channel section angle brace member having a first end, a second end, and a long axis, said first end being constructed and arranged to be affixed to said bottom portion of said substantially vertical tube, and said second end being constructed and arranged to be affixed to said distal end of said channel section support arm;
a lifting strap control assembly, said lifting strap control assembly including:
a windlass mounted at said proximal end and on said top surface of said channel section support arm;
a lifting strap guide bar mounted at said distal end of said support arm;
a lifting strap having sufficient length to both be wrapped around said windlass and to pass around said lifting strap guide bar;
said hoist support assembly being constructed and arranged to be collapsible whereby the long axes of said substantially vertical tube, said channel section support arm, and said channel section angle brace member become parallel one to another;
said hoist support assembly being constructed_out of a light metal so as to be transportable by an individual;
a base assembly including a pintle contained in a holster assembly, said pintle being constructed and arranged to engage said substantially vertical tube;
a base support assembly constructed and arranged for support of said holster assembly.

2. The portable hoist system as defined in claim 1 wherein said base support assembly is connectable to the tow bar assembly portion of a vehicle.

3. The portable hoist system as defined claim 1 wherein said connection of said top portion of said support arm and said substantially vertical tube is a pivotable connection.

4. The portable hoist system as defined in claim 1 wherein said angle brace member is foldable at a central pivotable connection.

5. The portable hoist system as defined in claim 10 wherein said angle brace member is foldable within said support arm.

6. A portable hoist system for use by an individual to lift loads into and remove loads from the cargo space of a vehicle having a tow bar assembly, said portable hoist system comprising:
at least one base assembly constructed and arranged for connection to the tow bar assembly of the vehicle, said base assembly including a pintle;
at least one hoist support assembly, said at least one hoist assembly including:
a substantially vertical tube having a bottom portion, a top portion, and a long axis, said bottom portion being constructed and arranged to rotatably engage said pintle;
a channel section support arm having a proximal end, a distal end, and a long axis, said proximal end being constructed and arranged to engage said top portion of said substantially vertical tube;
a channel section angle brace member having a first end, a second end, and a long axis, said first end being constructed and arranged to engage said bottom portion of said substantially vertical tube, and said second end being constructed and arranged to engage said distal end of said channel section support arm;
a lifting strap control assembly, said lifting strap control assembly including:
a windlass mounted at said proximal end of said channel section support arm;
a lifting strap guide bar mounted at said distal end of said channel support arm;
a lifting strap having sufficient length to both be wrapped around said windlass and passed around said lifting strap guide bar;
said at least one hoist assembly being constructed and arranged to be collapsible whereby the long axes of said substantially vertical tube, said channel section support arm, and said channel section angle brace become parallel to one another;
said hoist support assembly being constructed out of a light metal so as to be capable of being constructed and them mounted on said at least one base assembly in the cargo space of the vehicle by an individual.

7. The portable hoist system as defined in claim 1 wherein the height of said base assembly is adjustable.

8. A method for constructing a portable hoist system for a vehicle including a tow bar assembly which may be carried and erected by an individual and then rotatably mounted on a pintle; said method comprising the steps of:
(a) supporting said pintle by connection to the tow bar assembly;
(b) fabricating a hoist support assembly, said hoist support assembly including:
a substantially vertical tube having a bottom portion, and a top portion, said bottom portion being constructed and arranged to rotatably engage the pintle;
a channel section support arm having a proximal end, and a distal end, said proximal end being constructed and arranged to engage said top portion of said substantially vertical tube;
a channel section angle brace member having a first end and a second end, said first end being constructed and arranged to engage said bottom portion of said substantially-vertical tube and said second end being constructed and arranged to engage said distal end of said cross section support arm;
(c) attaching a lifting strap control assembly to said support arm, said lifting strap control assembly including:
a windlass mounted at said proximal end of said channel section support arm;
a lifting strap guide bar mounted at said distal end of said channel; section support arm;
a lifting strap having sufficient length to both be wrapped around said windlass and passed around said lifting strap guide bar;
(d) positioning the combination of said hoist support assembly and said cable control assembly on the pintle by, sliding said substantially vertical tube over the pintle.

9. A method for mounting a portable hoist assembly to a hitch receiver assembly, said hitch receiver assembly being attached to the rear of a vehicle, said method comprising of steps of:
inserting an extension arm into the hitch receiver assembly;
mounting a cross bar to said extension arm;
positioning a downwardly extending leg on either end of said cross bar to support said cross bar in a substantially horizontal position;
mounting said portable hoist assembly on a pintle extending upwardly from the area of the intersection of said extension arm and said crossbar.

10. The method as defined in claim 9 wherein a pivotable connection is formed between said extension arm and the hitch receiver assembly.

11. The method as defined in claim 9 wherein the length of said downwardly extending leg beneath said cross is adjustable.

12. The method as defined in claim 11 wherein said adjustable length is controlled by a pin passing through a hole in said downwardly extending leg.

13. A bipod support for a portable hoist assembly extending outwardly from a hitch receiver assembly, said hitch receiver assembly being attached to the rear of a vehicle, said bipod support comprising:
an extension arm constructed and arranged for interfitment with said hitch receiver assembly;
a cross bar constructed and arranged for engagement with said extension arm;
a slidably mounted leg positioned on either end of said cross bar;
an upwardly extending pintle constructed and arranged to support said hitch receiver assembly position on said cross bar where said cross bar engages said extension arm.

14. A method for mounting a portable hoist assembly to a hitch receiver assembly, said hitch receiver assembly being attached to the rear of a vehicle, said method comprising the steps of:
inserting a connection piece into the hitch receiver assembly;
mounting a substantially horizontal extension arm to said connection piece, said substantially horizontal extension arm extending to a corner of the vehicle supporting said extension arm at the corner of the vehicle with an adjustable leg;
mounting said portable hoist assembly in a holster positioned and extending upwardly from the areas of the intersection of said extension arm and said assembly leg.

15. A monopod support for a portable hoist assembly extending upwardly from a hitch receiver assembly, said hitch receiver assembly being attached to the rear of a vehicle, said monopod support comprising:
a connection piece constructed and arranged for interfitment with said hitch receiver assembly;
an extension arm connected to said connection piece on a first end;
an adjustable leg connected to the second end of said extension arm;
a holster constructed and arranged for mounting said portable hoist assembly extending upwardly from the area of the intersection of said extension arm and said adjustable leg.
